(19) United States
(12) Patent Application Publication
(10) Pub. No.: US 2015/0113595 A1
(43) Pub. Date: Apr. 23, 2015

(54) NETWORK ACCESS METHOD AND TERMINAL

(71) Applicant: Huawei Technologies Co., Ltd., Shenzhen (CN)

(72) Inventors: Mai WU, Shanghai (CN); Jun ZHOU, Shanghai (CN)

(21) Appl. No.: 14/516,102

(22) Filed: Oct. 16, 2014

(30) Foreign Application Priority Data
Oct. 23, 2013 (CN) 201310505278.X

(51) Int. Cl. H04W 12/08; H04W 76/02

(52) U.S. Cl. CPC H04W 12/08; H04W 76/021
USPC 726/3

(57) ABSTRACT

The present invention relates to the field of terminal technologies and provides a network access method and terminal, where the method includes: attempting to search for a network; when a network is successfully found, determining whether the found network is included in a blacklist; when the found network is included in the blacklist, accessing, in a restricted mode, a network that is found and included in the blacklist; and when the found network is not included in the blacklist, accessing, in a normal mode, a network that is found and not included in the blacklist. In a case in which a card lock technology is not used, a terminal, by using the network access method and terminal that are provided in the embodiments of the present invention, is capable of screening out a network of a competitor that is recorded in the blacklist.

### CROSS-REFERENCE TO RELATED APPLICATION

This application claims priority to Chinese Patent Application No. 201310505278.X, filed on Oct. 23, 2013, which is hereby incorporated by reference in its entirety.

### TECHNICAL FIELD

The present invention relates to the terminal field, and specifically, to a network access method and terminal.

### BACKGROUND

With rapid development of communications technologies, a terminal can support all or a part of five access technologies: Global System for Mobile Communications (GSM, Global System for Mobile Communications), Long Term Evolution (LTE, Long Term Evolution), Wideband Code Division Multiple Access (WCDMA, Wideband Code Division Multiple Access), Time Division-Synchronous Code Division Multiple Access (TD-SCDMA, Time Division-Synchronous Code Division Multiple Access), and Code Division Multiple Access (CDMA, Code Division Multiple Access), and such a terminal has also entered an era of extensive application. In order to seize market and limit development of a competitor, a carrier launches a customized terminal and makes the customized terminal be capable of accessing only a network provided by the carrier.

Generally, the customized terminal can connect to a network only after identifying a subscriber identity module (SIM, Subscriber Identity Module) or a type of SIM card.

It can be learned from the solution above that because a customized terminal can connect to some networks only when it identifies a card or a type of card, the customized terminal has little commonality, and SIM cards that match this type of customized terminal require mass production, and therefore this type of customized terminal requires a high cost.

### SUMMARY

Embodiments of the present invention provide a network access method and terminal, which are capable of screening out all or a part of networks of another carrier in a case in which a specific SIM card or a type of SIM card does not need to be identified.

A first aspect of the embodiments of the present invention discloses a network access method, and the method includes: attempting to search for a network; when a network is successfully found, determining whether the found network is included in a blacklist; when the found network is included in the blacklist, accessing, in a restricted mode, a network that is found and included in the blacklist; and when the found network is not included in the blacklist, accessing, in a normal mode, a network that is found and not included in the blacklist.

With reference to the first aspect, in a first implementation manner of the first aspect, the blacklist records a sketch value of a network; and

the determining whether the found network is included in the blacklist includes:

comparing a sketch value of the found network with the sketch value of the network recorded in the blacklist, so as to determine whether the found network is included in the blacklist.

With reference to the first aspect, or the first implementation manner of the first aspect, in a second implementation manner of the first aspect, before the attempting to search for a network, the method further includes:

receiving a network search instruction input by a user;

before the accessing, in a normal mode, a network that is found and not included in the blacklist, the method further includes:

displaying the network that is found and not included in the blacklist on a screen for the user to select, and

receiving a selection result; and

the accessing, in a normal mode, a network that is found and not included in the blacklist includes:

accessing, in the normal mode according to the selection result, the network that is found and not included in the blacklist.

With reference to the first aspect, or the first implementation manner of the first aspect, or the second implementation manner of the first aspect, in a third implementation manner of the first aspect, when the found network is included in the blacklist and if the number of networks that are found and included in the blacklist is at least two, the accessing, in a restricted mode, a network that is found and included in the blacklist includes:

selecting a network according to a preset rule, from the at least two networks that are found and included in the blacklist, and accessing, in the restricted mode, the selected network that is included in the blacklist.

With reference to the first aspect, or the first implementation manner of the first aspect, or the third implementation manner of the first aspect, in a fourth implementation manner of the first aspect,

when the found network is not included in the blacklist and if the number of networks not included in the blacklist is at least two, the accessing, in a normal mode, a network that is found and not included in the blacklist includes:

selecting a network according to the preset rule, from the at least two networks that are found and not included in the blacklist, and accessing, in the normal mode, the selected network that is not included in the blacklist.

A second aspect of the embodiments of the present invention discloses a terminal, and the terminal includes:

a searching unit, configured to attempt to search for a network; a determining unit, configured to determine, when the searching unit successfully finds a network, whether the network found by the searching unit is included in a blacklist; and an accessing unit, configured to: when the determining unit determines that the network found by the searching unit is included in the blacklist, access, in a restricted mode, a network that is found and included in the blacklist; and when the determining unit determines that the network found by the searching unit is not included in the blacklist, access, in a normal mode, a network that is found and not included in the blacklist.

With reference to the second aspect, in a first implementation manner of the second aspect, the determining unit is specifically configured to:

compare a sketch value of the network found by the searching unit with a sketch value of a network recorded in the blacklist, so as to determine whether the found network is included in the blacklist.

With reference to the second aspect, or the second implementation manner of the first aspect, in a second implementation manner of the second aspect, the terminal further includes a first receiving unit and a displaying unit:

the first receiving unit is configured to receive a network search instruction input by a user;

when the searching unit completes a network search, the displaying unit displays a network that is found by the searching unit and not included in the blacklist on a screen for the user to select;

the first receiving unit is further configured to receive a selection result; and

accessing, by the accessing unit in the normal mode, the network that is found and not included in the blacklist includes:

accessing, by the accessing unit in the normal mode according to the selection result received by the first receiving unit, the network that is found and not included in the blacklist.

With reference to the second aspect, or the first implementation manner of the second aspect, or the second implementation manner of the second aspect, in a third implementation manner of the second aspect, the determining unit is specifically configured to:

determine whether the found network is included in the blacklist and whether the number of networks that are comprised in the blacklist is not less than two; and

the accessing unit is specifically configured to:

when the determining unit determines that the found network is included in the blacklist and that the networks included in the blacklist are not less than two, select a network according to a preset rule, from the at least two networks that are found and included in the blacklist, and access, in the restricted mode, the selected network that is included in the blacklist.

With reference to the second aspect, or the first implementation manner of the second aspect, or the third implementation manner of the second aspect, in a fourth implementation manner of the second aspect, the determining unit is specifically configured to:

determine whether the found network is included in the blacklist and whether the number of networks that are not comprised in the blacklist is not less than two; and

the accessing unit is specifically configured to:

when the determining unit determines that the found network is not included in the blacklist and that the networks not included in the blacklist are not less than two, select a network according to the preset rule, from the at least two networks that are found and not included in the blacklist, and access, in the normal mode, the selected network that is not included in the blacklist.

It can be learned from the foregoing technical solutions according to embodiments of the present invention that because the embodiments of the present invention provide a blacklist, a terminal can connect to a network by using any SIM card and is capable of screening out a network of a competitor that is recorded in the blacklist, which limits development of the competitor and improves commonality of the terminal.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a network access method according to an embodiment of the present invention;

FIG. 2 is a flowchart of a network access method according to another embodiment of the present invention;

FIG. 3 is a flowchart of a network access method according to another embodiment of the present invention;

FIG. 4 is a flowchart of a network access method according to another embodiment of the present invention;

FIG. 5 is a structural diagram of a network access terminal according to an embodiment of the present invention;

FIG. 6 is a structural diagram of a network access terminal according to another embodiment of the present invention;

FIG. 7 is a structural diagram of a network access terminal according to another embodiment of the present invention;

FIG. 8 is a structural diagram of a network access terminal according to another embodiment of the present invention;

FIG. 9 is a structural diagram of a network access terminal according to another embodiment of the present invention;

FIG. 10 is a structural diagram of a network access terminal according to another embodiment of the present invention;

FIG. 11 is a structural diagram of a network access terminal according to another embodiment of the present invention; and

FIG. 12 is a structural diagram of a network access terminal according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

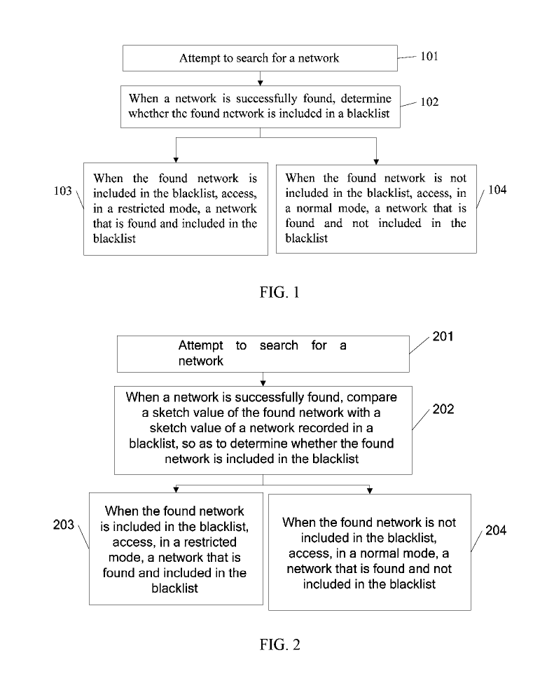

The following describes a network access method provided by an embodiment of the present invention according to FIG. 1, and the method describes a flow of accessing a network by a terminal, where the terminal may be a device such as a cell phone or a mobile phone. The method includes:

101. Attempt to search for a network.

The terminal may attempt to search for a network after being started, may also attempt to search for a network after receiving a network search instruction input by a user, may also attempt to search for a network in a case of network disconnection, may also attempt to search for a network in a case in which a network switching signal is received, and so on.

102. When a network is successfully found, determine whether the found network is included in a blacklist.

When the terminal is being started or searching for a network, the blacklist may be read into a memory, so as to acquire a sketch value of a network recorded in the blacklist, where the sketch value of the network includes a public land mobile network (PLMN, Public Land Mobile Network) ID and a radio access technology (RAT, Radio Access Technology) ID. The blacklist may be stored in the terminal.

In an embodiment of the present invention, a PLMN is a network that is established and operated by a government or an operator approved by the government to provide land mobile communications services for the public. The PLMN ID is formed by a mobile country code and a mobile network code, where the mobile country code is formed by three digits. A RAT represents a radio access technology, for example, Global System for Mobile Communications (GSM, Global System for Mobile Communications), Long Term Evolution (LTE, Long Term Evolution), Wideband Code Division Multiple Access (WCDMA, Wideband Code Division Multiple Access), Time Division-Synchronous Code Division Multiple Access (TD-SCDMA, Time Division-Synchronous Code Division Multiple Access), and Code Division Multiple Access (CDMA, Code Division Multiple Access). Therefore, a combination of the PLMN and the RAT may indicate an access network of a carrier.

If there is network coverage at a location of the terminal, all networks that cover the location of the terminal may be found when a network search is performed, and sketch values of the found networks are compared with the sketch value of the network recorded in the blacklist, so as to determine whether the found networks are included in the blacklist; and if there is no network coverage at the location of the terminal, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

103. When the found network is included in the blacklist, access, in a restricted mode, a network that is found and included in the blacklist.

After the sketch values of the found networks are compared with the sketch value of the network recorded in the blacklist, if all the found networks are included in the blacklist, one of the found networks is selected at random and accessed in the restricted mode; emergency services are available to the terminal in the restricted mode, for example, making emergency calls 110, 119, 120, and the like; in the restricted mode, the terminal keeps on attempting to search for another network, and once a network that is not included in the blacklist is found, network switching is performed. Accessing, in the restricted mode, the network that is found and included in the blacklist refers to accessing a cell network of the network, instead of accessing a core network. When no network can be accessed, the terminal camps on a network of a competitor, and the user enjoys the emergency services and can respond to emergencies.

104. When the found network is not included in the blacklist, access, in a normal mode, a network that is found and not included in the blacklist.

After the sketch values of the found networks are compared with the sketch value of the network recorded in the blacklist, if networks that are found and not included in the blacklist exist, a network with a strongest signal may be selected and accessed, or a network may be selected at random and accessed, or the user may also independently select a network to access, thereby improving user experience.

It can be learned from the foregoing that in a network access method provided in this embodiment of the present invention, because this embodiment of the present invention provides a blacklist, a terminal can connect to a network by using any SIM card and is capable of screening out a network of a competitor that is recorded in the blacklist, which limits development of the competitor and improves commonality of the terminal.

FIG. 2 describes a network access method according to another embodiment of the present invention.

201. Attempt to search for a network.

A terminal may attempt to search for a network after being started, may also attempt to search for a network after receiving a network search instruction input by a user, may also attempt to search for a network in a case of network disconnection, may also attempt to search for a network in a case in which a network switching signal is received, and so on. Attempting to search for a network includes acquiring a sketch value of a found network, where the sketch value includes a public land mobile network (PLMN, Public Land Mobile Network) ID and a radio access technology (RAT, Radio Access Technology) ID of the network.

202. When a network is successfully found, compare a sketch value of the found network with a sketch value of a network recorded in a blacklist, so as to determine whether the found network is included in the blacklist.

When the terminal is being started or searching for a network, the blacklist may be read into a memory, so as to acquire the sketch value of the network recorded in the blacklist, where the sketch value of the network includes a PLMN ID and a RAT ID. The blacklist may be stored in the terminal.

In an embodiment of the present invention, the PLMN is a network that is established and operated by a government or an operator approved by the government to provide land mobile communications services for the public. The PLMN ID is formed by a mobile country code and a mobile network code, where the mobile country code is formed by three digits. The RAT represents a radio access technology, for example, Global System for Mobile Communications (GSM, Global System for Mobile Communications), Long Term Evolution (LTE, Long Term Evolution), Wideband Code Division Multiple Access (WCDMA, Wideband Code Division Multiple Access), Time Division-Synchronous Code Division Multiple Access (TD-SCDMA, Time Division-Synchronous Code Division Multiple Access), and Code Division Multiple Access (CDMA, Code Division Multiple Access). Therefore, a combination of the PLMN and the RAT may indicate an access network of a carrier.

If there is network coverage at a location of the terminal, all networks that cover the location of the terminal may be found when a network search is performed, and sketch values of the found networks are compared with the sketch value of the network recorded in the blacklist, so as to determine whether the found networks are included in the blacklist; and if there is no network coverage at the location of the terminal, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

203. When the found network is included in the blacklist, access, in a restricted mode, a network that is found and included in the blacklist.

After the sketch values of the found networks are compared with the sketch value of the network recorded in the blacklist, if all the found networks are included in the blacklist, one of the found networks is selected at random and accessed in the restricted mode; emergency services are available to the terminal in the restricted mode, for example, making emergency calls 110, 119, 120, and the like; in the restricted mode, the terminal keeps on attempting to search for another network, and once a network not included in the blacklist is found, network switching is performed. Accessing, in the restricted mode, the network that is found and included in the blacklist refers to accessing a cell network of the network, instead of accessing a core network. When no network can be accessed, the terminal camps on a network of a competitor, and the user enjoys the emergency services and can respond to emergencies.

204. When the found network is not included in the blacklist, access, in a normal mode, a network that is found and not included in the blacklist.

After the sketch values of the found networks are compared with the sketch value of the network recorded in the blacklist, if networks that are found and not included in the blacklist exist, a network with a strongest signal may be selected and accessed, or a network may be selected at random and accessed, or the user may also independently select a network to access, thereby improving user experience.

It can be learned from the foregoing that in a network access method provided in this embodiment of the present invention, because this embodiment of the present invention provides a blacklist, a terminal can connect to a network by using any SIM card and is capable of screening out a network of a competitor that is recorded in the blacklist, which limits development of the competitor and improves commonality of the terminal.

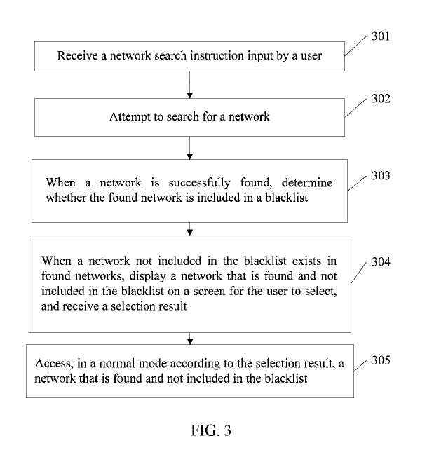

FIG. 3 describes a network access method according to another embodiment of the present invention.

301. Receive a network search instruction input by a user.

When a current terminal has no network connection or has a poor network signal, the user may enter the network search instruction to search for a network again.

302. Attempt to search for a network.

After receiving the network search instruction input by the user, the terminal attempts to search for a network. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

303. When a network is successfully found, determine whether the found network is included in a blacklist.

When the terminal is being started or searching for a network, the blacklist may be read into a memory, so as to acquire a sketch value of a network recorded in the blacklist, where the sketch value of the network is formed by a public land mobile network (PLMN, Public Land Mobile Network) ID and a radio access technology (RAT, Radio Access Technology) ID. The blacklist may be stored in the terminal.

In an embodiment of the present invention, a PLMN is a network that is established and operated by a government or an operator approved by the government to provide land mobile communications services for the public. The PLMN ID is formed by a mobile country code and a mobile network code, where the mobile country code is formed by three digits. A RAT represents a radio access technology, for example, Global System for Mobile Communications (GSM, Global System for Mobile Communications), Long Term Evolution (LTE, Long Term Evolution), Wideband Code Division Multiple Access (WCDMA, Wideband Code Division Multiple Access), Time Division-Synchronous Code Division Multiple Access (TD-SCDMA, Time Division-Synchronous Code Division Multiple Access), and Code Division Multiple Access (CDMA, Code Division Multiple Access). Therefore, a combination of the PLMN and the RAT may indicate an access network of a carrier.

If there is network coverage at a location of the terminal, all networks that cover the location of the terminal may be found when a network search is performed, and sketch values of the found networks are compared with the sketch value of the network recorded in the blacklist, so as to determine whether the found networks are included in the blacklist; and if there is no network coverage at the location of the terminal locates, the user is prompted that services in this area are restricted.

304. When a network not included in the blacklist exists in found networks, display a network that is found and not included in the blacklist on a screen for the user to select, and receive a selection result.

After the found networks are compared with a network recorded in the blacklist, a network included in the blacklist is screened out, and a network not included in the blacklist is displayed on the screen for the user to select and the selection result is received. Directly screening out a network that is found and included in the blacklist helps reduce a possibility of using a competitive network of a competitor by the user, so as to limit development of the competitor.

305. Access, in a normal mode according to the selection result, a network that is found and not included in the blacklist.

The network that is found and not included in the blacklist is accessed in the normal mode according to the received selection result of the user, so that the terminal may perform normal communication.

It can be learned from the foregoing that in a network access method provided in this embodiment of the present invention, because this embodiment of the present invention provides a blacklist, a terminal can connect to a network by using any SIM card and is capable of screening out a network of a competitor that is recorded in the blacklist, which limits development of the competitor and improves commonality of the terminal.

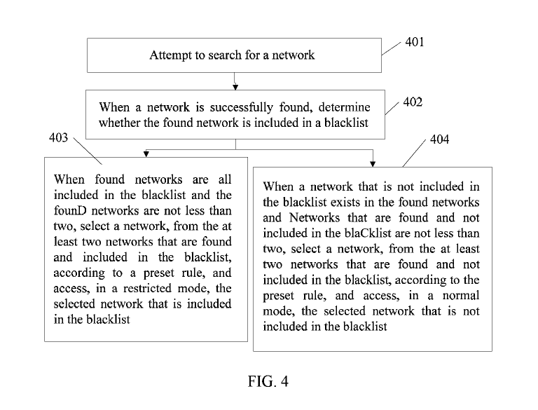

FIG. 4 describes a network access method according to another embodiment of the present invention.

401. Attempt to search for a network.

A terminal may attempt to search for a network after being started, may also attempt to search for a network after receiving a network search instruction input by a user, may also attempt to search for a network in a case of network disconnection, may also attempt to search for a network in a case in which a network switching signal is received, and so on.

402. When a network is successfully found, determine whether the found network is included in a blacklist.

When the terminal is being started or searching for a network, the blacklist may be read into a memory, so as to acquire a sketch value of a network recorded in the blacklist, where the sketch value of the network is formed by a public land mobile network (PLMN, Public Land Mobile Network) ID and a radio access technology (RAT, Radio Access Technology) ID. The blacklist may be stored in the terminal.

In an embodiment of the present invention, a PLMN is a network that is established and operated by a government or an operator approved by the government to provide land mobile communications services for the public. The PLMN ID is formed by a mobile country code and a mobile network code, where the mobile country code is formed by three digits. A RAT represents a radio access technology, for example, Global System for Mobile Communications (GSM, Global System for Mobile Communications), Long Term Evolution (LTE, Long Term Evolution), Wideband Code Division Multiple Access (WCDMA, Wideband Code Division Multiple Access), Time Division-Synchronous Code Division Multiple Access (TD-SCDMA, Time Division-Synchronous Code Division Multiple Access), and Code Division Multiple Access (CDMA, Code Division Multiple Access). Therefore, a combination of the PLMN and the RAT may indicate an access network of a carrier.

If there is network coverage at a location of the terminal, all networks that cover the location of the terminal may be found when a network search is performed, and sketch values of the found networks are compared with the sketch value of the network recorded in the blacklist, so as to determine whether the found networks are included in the blacklist; and if there is no network coverage at the location of the terminal, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

403. When found networks are all included in the blacklist and the found networks are not less than two, select a network according to a preset rule, from the at least two networks that are found and included in the blacklist, and access, in a restricted mode, the selected network that is included in the blacklist.

After the sketch values of the found networks are compared with the sketch value of the network recorded in the blacklist, if the found networks are all included in the blacklist and the number of found networks is not less than two, a network is selected, from the networks that are found and included in the blacklist, at random according to the preset rule, and accessed in the restricted mode; emergency services are available to the terminal in the restricted mode, for example, making emergency calls 110, 119, 120, and the like; in the restricted mode, the terminal keeps on attempting to search for another network, and once a network not included in the blacklist is found, network switching is performed. The preset rule refers to a rule that is set beforehand, for example, access is performed according to signal strength, or according to a random sequence. Accessing, in the restricted mode, the network that is found and included in the blacklist refers to accessing a cell network of the network, instead of accessing a core network. When no network can be accessed, the terminal camps on a network of a competitor, and the user enjoys the emergency services and can respond to emergencies.

404. When a network not included in the blacklist exists in the found networks and networks that are found and not included in the blacklist are not less than two, select a network according to the preset rule, from the at least two networks that are found and not included in the blacklist, and access, in a normal mode, the selected network that is not included in the blacklist.

After the sketch values of the found networks are compared with the sketch value of the network recorded in the blacklist, if networks that are found and not included in the blacklist exist and the found networks are not less than two, a network is selected, from the networks that are found and included in the blacklist, according to the preset rule, and accessed in the normal mode. The preset rule refers to a rule that is set beforehand, for example, access is performed according to signal strength, or according to a random sequence.

It can be learned from the foregoing that in a network access method provided in this embodiment of the present invention, because this embodiment of the present invention provides a blacklist, a terminal can connect to a network by using any SIM card and is capable of screening out a network of a competitor that is recorded in the blacklist, which limits development of the competitor and improves commonality of the terminal.

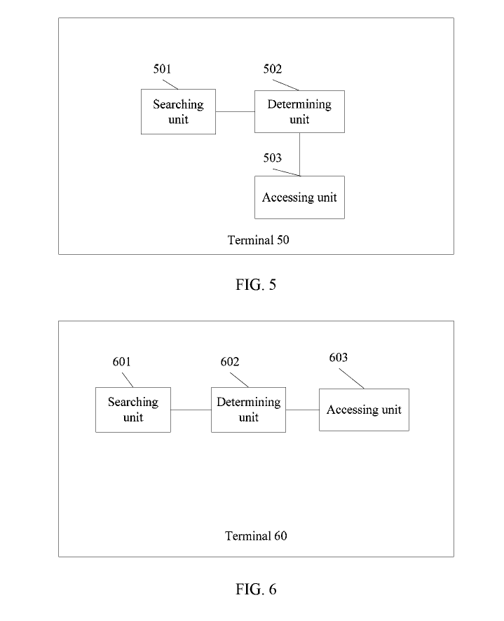

The following describes a terminal 50 provided by an embodiment of the present invention according to FIG. 5, and as shown in FIG. 5, the terminal 50 includes: a searching unit 501, a determining unit 502, and an accessing unit 503.

The searching unit 501 is configured to attempt to search for a network.

The searching unit 501 may attempt to search for a network after the terminal 50 is started, may also attempt to search for a network after receiving a network search instruction input by a user, may also attempt to search for a network in a case of network disconnection, may also attempt to search for a network in a case in which a network switching signal is received, and so on.

The determining unit 502 is configured to determine, when the searching unit 501 successfully finds a network, whether the network found by the searching unit 501 is included in a blacklist.

A sketch value of a network is stored in the blacklist, and the sketch value of the network is formed by a public land mobile network (PLMN, Public Land Mobile Network) ID and a radio access technology (RAT, Radio Access Technology) ID. The blacklist may be stored in the terminal.

If there is network coverage at a location of the terminal, all networks that cover the location of the terminal may be found when a network search is performed, and the determining unit 502 compares sketch values of the networks found by the searching unit 501 with the sketch value of the network recorded in the blacklist, so as to determine whether the found networks are included in the blacklist; and if there is no network coverage at the location of the terminal, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

The accessing unit 503 is configured to: when the determining unit 502 determines that the network found by the searching unit 501 is included in the blacklist, access, in a restricted mode, a network that is found and included in the blacklist; and when the determining unit 502 determines that a network not included in the blacklist exists in networks found by the searching unit 501, access, in a normal mode, a network that is found and not included in the blacklist.

After the determining unit 502 compares the sketch value of the found network with the sketch value of the network recorded in the blacklist, if all found networks are included in the blacklist, the accessing unit 503 selects one of the found networks at random and accesses the selected network in the restricted mode; emergency services are available to the terminal in the restricted mode, for example, making emergency calls 110, 119, 120, and the like; in the restricted mode, the terminal keeps on attempting to search for another network, and once a network not included in the blacklist is found, network switching is performed. Accessing, in the restricted mode, the network that is found and included in the blacklist refers to accessing a cell network of the network, instead of accessing a core network. When no network can be accessed, the terminal camps on a network of a competitor, and the user enjoys the emergency services and can respond to emergencies.

After the determining unit 502 compares the sketch value of the found network with the sketch value of the network recorded in the blacklist, if networks that are found and not included in the blacklist exist, the accessing unit 503 may select a network with a strongest signal to access, or may also select a network at random to access, or the user may also independently select a network to access, thereby improving user experience.

It can be learned from the foregoing that in a network access terminal provided in this embodiment of the present invention, because this embodiment of the present invention provides a blacklist, the terminal can connect to a network by using any SIM card and is capable of screening out a network of a competitor that is recorded in the blacklist, which limits development of the competitor and improves commonality of the terminal.

The following describes a terminal 60 provided by an embodiment of the present invention according to FIG. 6, and as shown in FIG. 6, the terminal 60 includes:

a searching unit 601, a determining unit 602, and an accessing unit 603.

The searching unit 601 is configured to attempt to search for a network.

The searching unit 601 may attempt to search for a network after the terminal is started, may also attempt to search for a network after receiving a network search instruction input by a user, may also attempt to search for a network in a case of network disconnection, may also attempt to search for a network in a case in which a network switching signal is received, and so on. Attempting to search for a network includes acquiring a sketch value of a found network, where the sketch value includes a public land mobile network (PLMN, Public Land Mobile Network) ID and a radio access technology (RAT, Radio Access Technology) ID of the network.

The determining unit 602 is configured to compare, when the searching unit 601 successfully finds a network, a sketch value of the found network with a sketch value of a network recorded in a blacklist, so as to determine whether the found network is included in the blacklist.

If there is network coverage at a location of the terminal, all networks that cover the location of the terminal may be found when a network search is performed, and the determining unit 602 compares sketch values of the networks found by the searching unit 601 with the sketch value of the network recorded in the blacklist, so as to determine whether the found networks are included in the blacklist; and if there is no network coverage at the location of the terminal, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

The accessing unit 603 is configured to: when the determining unit 602 determines that the network found by the searching unit 601 is included in the blacklist, access, in a restricted mode, a network that is found and included in the blacklist; and when the determining unit 602 determines that a network not included in the blacklist exists in networks found by the searching unit 601, access, in a normal mode, a network that is found and not included in the blacklist.

After the determining unit 602 compares the sketch value of the found network with the sketch value of the network recorded in the blacklist, if all found networks are included in the blacklist, the accessing unit 603 selects one of the found networks at random and accesses the selected network in the restricted mode; emergency services are available to the terminal in the restricted mode, for example, making emergency calls 110, 119, 120, and the like; in the restricted mode, the terminal keeps on attempting to search for another network, and once a network not included in the blacklist is found, network switching is performed. Accessing, in the restricted mode, the network that is found and included in the blacklist refers to accessing a cell network of the network, instead of accessing a core network. When no network can be accessed, the terminal camps on a network of a competitor, and the user enjoys the emergency services and can respond to emergencies.

After the determining unit 602 compares the sketch value of the found network with the sketch value of the network recorded in the blacklist, if networks that are found and not included in the blacklist exist, the accessing unit 603 may select a network with a strongest signal to access, or may also select a network at random to access, or the user may also independently select a network to access, thereby improving user experience.

It can be learned from the foregoing that in a network access terminal provided in this embodiment of the present invention, because this embodiment of the present invention provides a blacklist, in a case in which a card lock technology is not used, a terminal is capable of screening out a network of a competitor that is recorded in the blacklist, which limits development of the competitor and improves commonality of the terminal.

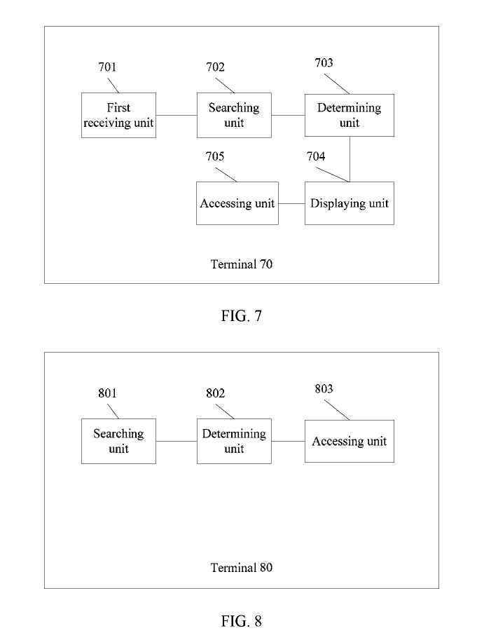

The following describes a terminal 70 provided by an embodiment of the present invention according to FIG. 7, and as shown in FIG. 7, the terminal 70 includes:

a first receiving unit 701, a searching unit 702, a determining unit 703, a displaying unit 704, and an accessing unit 705.

The first receiving unit 701 is configured to receive a network search instruction input by a user.

When a current terminal has no network connection or has a poor network signal, the first receiving unit 701 may receive the network search instruction input by the user.

The searching unit 702 is configured to attempt to search for a network.

The searching unit 702 attempts to search for a network when the first receiving unit 701 receives the network search instruction input by the user. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

The determining unit 703 is configured to determine, when the searching unit 702 successfully finds a network, whether the network found by the searching unit 702 is included in a blacklist.

A sketch value of a network is stored in the blacklist, and the sketch value of the network is formed by a public land mobile network (PLMN, Public Land Mobile Network) ID and a radio access technology (RAT, Radio Access Technology) ID. The blacklist may be stored in the terminal.

If there is network coverage at a location of the terminal, all networks that cover the location of the terminal may be found when a network search is performed, and the determining unit 703 compares sketch values of the networks found by the searching unit 702 with the sketch value of the network recorded in the blacklist, so as to determine whether the found networks are included in the blacklist; and if there is no network coverage at the location of the terminal, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

The displaying unit 704 displays, when the determining unit 703 determines that a network not included in the blacklist exists in found networks, a network that is found and not included in the blacklist on a screen for the user to select, and the first receiving unit 701 is further configured to receive a selection result.

After the determining unit 703 compares a found network with a network recorded in the blacklist, the displaying unit 704 screens out a network included in the blacklist, and displays a network not included in the blacklist on the screen for the user to select, and the first receiving unit 701 is further configured to receive the selection result of the user. Directly screening out a network that is found and included in the blacklist helps reduce a possibility of using a competitive network of a competitor by the user, so as to limit development of the competitor.

The accessing unit 705 is configured to access, in a normal mode according to the selection result received by the first receiving unit 701, the network that is found and not included in the blacklist.

It can be learned from the foregoing that in a network access terminal provided in this embodiment of the present invention, because this embodiment of the present invention provides a blacklist, a terminal can connect to a network by using any SIM card and is capable of screening out a network of a competitor that is recorded in the blacklist, which limits development of the competitor and improves commonality of the terminal.

The following describes a terminal 80 of an embodiment of the present invention according to FIG. 8, and as shown in FIG. 8, the terminal 80 includes:

a searching unit 801, a determining unit 802, and an accessing unit 803.

The searching unit 801 is configured to attempt to search for a network.

The searching unit 801 may attempt to search for a network after the terminal is started, may also attempt to search for a network after receiving a network search instruction input by a user, may also attempt to search for a network in a case of network disconnection, may also attempt to search for a network in a case in which a network switching signal is received, and so on.

The determining unit 802 is configured to determine, when the searching unit 801 successfully finds a network, whether the network found by the searching unit 801 is included in a blacklist.

A sketch value of a network is stored in the blacklist, and the sketch value of the network is formed by a public land mobile network (PLMN, Public Land Mobile Network) ID and a radio access technology (RAT, Radio Access Technology) ID. The blacklist may be stored in the terminal.

If there is network coverage at a position at which the terminal locates, all networks that cover the position at which the terminal locates may be found when a network search is performed, and the determining unit 802 compares sketch values of the networks found by the searching unit 801 with the sketch value of the network recorded in the blacklist, so as to determine whether the found networks are included in the blacklist; and if there is no network coverage at the position at which the terminal locates, the user is prompted that services in this area are restricted. For example, when attempting to search for a network in Shenzhen, a terminal may find a CDMA network provided by China Telecom, a TD-SCDMA network provided by China Mobile, a GSM network provided by China Mobile, a WCDMA network provided by China Unicom, a GSM network provided by China Unicom, an LTE network provided by China Mobile, and the like.

The accessing unit 803 is configured to: when the determining unit 802 determines that networks that are found by the searching unit 801 are all included in the blacklist and the found networks are not less than two, select a network according to a preset rule, from the at least two networks that are found and included in the blacklist, and access, in a restricted mode, the selected network that is included in the blacklist; when the determining unit 802 determines that a network that is not included in the blacklist exists in the networks that are found by the searching unit 801 and networks that are found and not included in the blacklist are not less than two, select a network according to the preset rule, from the at least two networks that are found and not included in the blacklist, and access, in a normal mode, the selected network that is not included in the blacklist.

After the determining unit 802 compares the sketch value of the found network with the sketch value of the network recorded in the blacklist, if the found networks are all included in the blacklist and the number of found networks is not less than two, a network is selected, from the networks that are found and included in the blacklist, at random according to the preset rule, and accessed in the restricted mode; emergency services are available for the terminal in the restricted mode, for example, making emergency calls 110, 119, 120, and the like; in the restricted mode, the terminal keeps on attempting to search for another network, and once a network not included in the blacklist is found, network switching is performed. The preset rule refers to a rule that is set beforehand, for example, access is performed according to signal strength, or according to a random sequence. Accessing, in the restricted mode, the network that is found and included in the blacklist refers to accessing a cell network of the network, instead of accessing a core network. When no network can be accessed, the terminal camps on a network of a competitor, and the user enjoys the emergency services and can respond to emergencies.

After the determining unit 802 compares the sketch value of the found network with the sketch value of the network recorded in the blacklist, if networks that are found and not included in the blacklist exist and the found networks are not less than two, a network is selected, from the networks that are found and not included in the blacklist, according to the preset rule, and accessed in the normal mode. The preset rule refers to a rule that is set beforehand, for example, access is performed according to signal strength, or according to a random sequence.

It can be learned from the foregoing that in a network access terminal provided in this embodiment of the present invention, because this embodiment of the present invention provides a blacklist, the terminal can connect to a network by using any SIM card and is capable of screening out a network of a competitor that is recorded in the blacklist, which limits development of the competitor and improves commonality of the terminal.

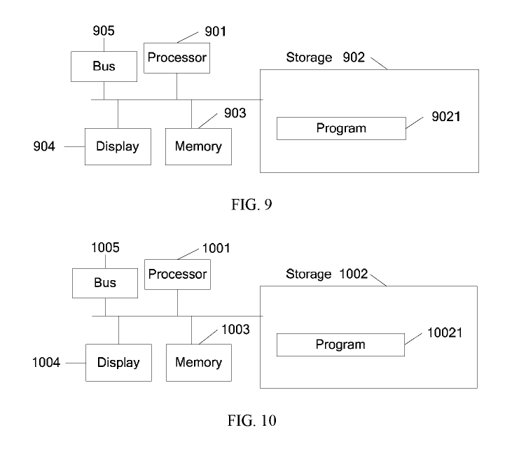

FIG. 9 describes a terminal provided in another embodiment of the present invention, where the terminal includes at least one processor 901 (for example, a CPU), a storage 902, a memory 903, a display 904, and at least one communications bus 905, which is configured to implement connection and communication between these apparatuses. The processor 901 is configured to execute an executable module, such as a computer program, stored in the storage 902. The storage 902 may include a high-speed random access memory (RAM: Random Access Memory) and may further include a non-volatile memory (non-volatile memory), such as at least one disk memory. An address in the memory is accessed by means of the at least one processor.

In some implementation manners, the storage 902 stores a program 9021, where the program 9021 may be executed by the processor 901, and this program includes: attempting to search for a network; when a network is successfully found, determining whether the found network is included in a blacklist; when the found network is included in the blacklist, accessing, in a restricted mode, a network that is found and included in the blacklist; and when the found network is not included in the blacklist, accessing, in a normal mode, a network that is found and not included in the blacklist. Specific implementation steps are the same as an embodiment shown in FIG. 1, and details are not described herein again.

It can be learned from the foregoing that in a network access terminal provided in this embodiment of the present invention, because this embodiment of the present invention provides a blacklist, the terminal can connect to a network by using any SIM card and is capable of screening out a network of a competitor that is recorded in the blacklist, which limits development of the competitor and improves commonality of the terminal.

FIG. 10 describes a terminal provided in another embodiment of the present invention, where the terminal includes at least one processor 1001 (for example, a CPU), a storage 1002, a memory 1003, a display 1004, and at least one communications bus 1005, which is configured to implement connection and communications between these apparatuses. The processor 1001 is configured to execute an executable module, such as a computer program, stored in the storage 1002. The storage 1002 may include a high-speed random access memory (RAM: Random Access Memory) and may further include a non-volatile memory (non-volatile memory), such as at least one disk memory. An address in the memory is accessed by means of the at least one processor.

In some implementation manners, the storage 1002 stores a program 10021, where the program 10021 may be executed by the processor 1001, and this program includes: attempting to search for a network; when a network is successfully found, comparing a sketch value of the found network with a sketch value of a network recorded in a blacklist, so as to determine whether the found network is included in the blacklist; when the found network is included in the blacklist, accessing, in a restricted mode, a network that is found and included in the blacklist; and when the found network is not included in the blacklist, accessing, in a normal mode, a network that is found and not included in the blacklist. Specific implementation steps are the same as an embodiment shown in FIG. 2, and details are not described herein again.

It can be learned from the foregoing that in a network access terminal provided in this embodiment of the present invention, because this embodiment of the present invention provides a blacklist, the terminal can connect to a network by using any SIM card and is capable of screening out a network of a competitor that is recorded in the blacklist, which limits development of the competitor and improves commonality of the terminal.

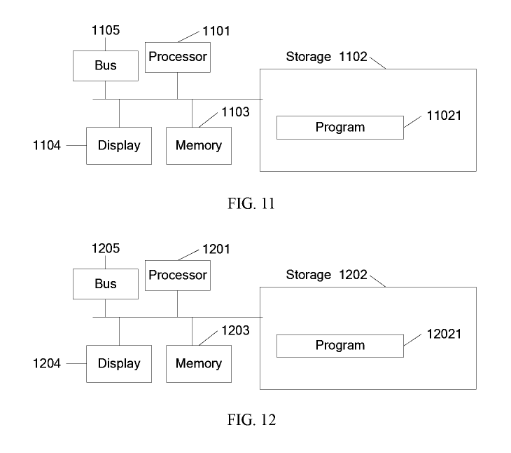

FIG. 11 describes a terminal provided in another embodiment of the present invention, where the terminal includes at least one processor 1101 (for example, a CPU), a storage 1102, a memory 1103, a display 1104, and at least one communications bus 1105, which is configured to implement connection and communication between these apparatuses. The processor 1101 is configured to execute an executable module, such as a computer program, stored in the storage 1102. The storage 1102 may include a high-speed random access memory (RAM: Random Access Memory) and may further include a non-volatile memory (non-volatile memory), such as at least one disk memory. An address in the memory is accessed by means of the at least one processor.

In some implementation manners, the storage 1102 stores a program 11021, where the program 11021 may be executed by the processor 1101, and this program includes: receiving a network search instruction input by a user; attempting to search for a network; when a network is successfully found, determining whether the found network is included in a blacklist; when a network not included in the blacklist exists in found networks, displaying a network that is found and not included in the blacklist on a screen for the user to select; and receiving a selection result of the user, and accessing a corresponding network according to the selection result. Specific implementation steps are the same as an embodiment shown in FIG. 3, and details are not described herein again.

It can be learned from the foregoing that in a network access terminal provided in this embodiment of the present invention, because this embodiment of the present invention provides a blacklist, the terminal can connect to a network by using any SIM card and is capable of screening out a network of a competitor that is recorded in the blacklist, which limits development of the competitor and improves commonality of the terminal.

FIG. 12 describes a terminal provided in another embodiment of the present invention, where the terminal includes at least one processor 1201 (for example, a CPU), a storage 1202, a memory 1203, a display 1204, and at least one communications bus 1205, which is configured to implement connection and communication between these apparatuses. The processor 1201 is configured to execute an executable module, such as a computer program, stored in the storage 1202. The storage 1202 may include a high-speed random access memory (RAM: Random Access Memory) and may further include a non-volatile memory (non-volatile memory), such as at least one disk memory. An address in the memory is accessed by means of the at least one processor.

In some implementation manners, the storage 1202 stores a program 12021, where the program 12021 may be executed by the processor 1201, and this program includes: attempting to search for a network; when a network is successfully found, determining whether the found network is included in a blacklist; when found networks are all included in the blacklist and the found networks are not less than two, selecting a network according to a preset rule, from the at least two networks that are found and included in the blacklist, and accessing, in a restricted mode, the selected network that is included in the blacklist; when a network not included in the blacklist exists in the found networks and networks that are found and not included in the blacklist are not less than two, selecting a network according to the preset rule, from the at least two networks that are found and not included in the blacklist, and accessing, in a normal mode, the selected network that is not included in the blacklist. Specific implementation steps are the same as an embodiment shown in FIG. 4, and details are not described herein again.

It can be learned from the foregoing that in a network access terminal provided in this embodiment of the present invention, because this embodiment of the present invention provides a blacklist, the terminal can connect to a network by using any SIM card and is capable of screening out a network of a competitor that is recorded in the blacklist, which limits development of the competitor and improves commonality of the terminal.

It should be noted that, for ease of description, the foregoing method embodiments are all described as combinations of actions but those skilled in the art should know that the present invention is not limited to the described sequences of actions. According to the present invention, some steps may be executed in other sequences or executed simultaneously. It should be further understood by a person skilled in the art that the described embodiments all belong to exemplary embodiments, and the involved actions and modules are not necessarily required by the present invention.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (Read-Only Memory, ROM), or a random access memory (Random Access Memory, RAM).

Specific examples are used in this specification to describe the principle and implementation manners of the present invention. The descriptions of the foregoing embodiments are merely intended to help understand the method and idea of the present invention. In addition, with respect to the implementation manners and the application scope, modifications may be made by a person of ordinary skill in the art according to the idea of the present invention. Therefore, this specification shall not be construed as a limitation on the present invention.

What is claimed is:

1. A network access method, comprising:
attempting to search for a network;
when a network is successfully found, determining whether the found network is comprised in a blacklist;
when the found network is comprised in the blacklist, accessing, in a restricted mode, a network that is found and comprised in the blacklist; and
when the found network is not comprised in the blacklist, accessing, in a normal mode, a network that is found and not comprised in the blacklist.

2. The network access method according to claim 1, wherein the blacklist records a sketch value of a network, and
the determining whether the found network is comprised in a blacklist comprises:
comparing a sketch value of the found network with the sketch value of the network recorded in the blacklist, so as to determine whether the found network is comprised in the blacklist.

3. The network access method according to claim 1, wherein before the attempting to search for a network, the method further comprises:
receiving a network search instruction input by a user;
before the accessing, in a normal mode, a network that is found and not comprised in the blacklist, the method further comprises:
displaying the network that is found and not comprised in the blacklist on a screen for the user to select, and receiving a selection result; and
the accessing, in a normal mode, a network that is found and not comprised in the blacklist comprises:
accessing, in the normal mode according to the selection result, the network that is found and not comprised in the blacklist.

4. The network access method according to claim 1, wherein when the found network is comprised in the blacklist and if the number of networks that are found and comprised in the blacklist is at least two, the accessing, in a restricted mode, a network that is found and comprised in the blacklist comprises:
selecting a network according to a preset rule, from the at least two networks that are found and comprised in the blacklist, and accessing, in the restricted mode, the selected network that is comprised in the blacklist.

5. The network access method according to claim 1, wherein when the found network is not comprised in the blacklist and if the number of networks that are not comprised in the blacklist is at least two, the accessing, in a normal mode, a network that is found and not comprised in the blacklist comprises:
selecting a network according to the preset rule, from the at least two networks that are found and not comprised in the blacklist, and accessing, in the normal mode, the selected network that is not comprised in the blacklist.

6. A terminal, comprising:
a searching unit, configured to attempt to search for a network;
a determining unit, configured to determine, when the searching unit successfully finds a network, whether the network found by the searching unit is comprised in a blacklist; and
an accessing unit, configured to: when the determining unit determines that the network found by the searching unit is comprised in the blacklist, access, in a restricted mode, a network that is found and comprised in the blacklist; and when the determining unit determines that the network found by the searching unit is not comprised in the blacklist, access, in a normal mode, a network that is found and not comprised in the blacklist.

7. The terminal according to claim 6, wherein the determining unit is specifically configured to:
compare a sketch value of the network found by the searching unit with a sketch value of a network recorded in the blacklist, so as to determine whether the found network is comprised in the blacklist.

8. The terminal according to claim 6, further comprising a first receiving unit and a displaying unit:
the first receiving unit is configured to receive a network search instruction input by a user;
when the searching unit completes a network search, the displaying unit displays a network that is found by the searching unit and not comprised in the blacklist on a screen for the user to select;
the first receiving unit is further configured to receive a selection result; and
accessing, by the accessing unit in the normal mode, the network that is found and not comprised in the blacklist comprises:
accessing, by the accessing unit in the normal mode according to the selection result received by the first receiving unit, the network that is found and not comprised in the blacklist.

9. The terminal according to claim 6, wherein the determining unit is specifically configured to:
determine whether the found network is comprised in the blacklist and whether the number of networks that are comprised in the blacklist is not less than two; and
the accessing unit is specifically configured to:
when the determining unit determines that the found network is comprised in the blacklist and that the networks that are comprised in the blacklist are not less than two, select a network according to a preset rule, from the at least two networks that are found and comprised in the blacklist, and access, in the restricted mode, the selected network that is comprised in the blacklist.

10. The terminal according to claim 6, wherein the determining unit is specifically configured to:
determine whether the found network is comprised in the blacklist and whether the number of networks that are not comprised in the blacklist is not less than two; and
the accessing unit is specifically configured to:
when the determining unit determines that the found network is not comprised in the blacklist and that the networks that are not comprised in the blacklist are not less than two, select a network according to the preset rule, from the at least two networks that are found and not comprised in the blacklist, and access, in the normal mode, the selected network that is not comprised in the blacklist.
